(19) United States
(12) Patent Application Publication
(10) Pub. No.: US 2011/0183079 A1
(43) Pub. Date: Jul. 28, 2011

(54) PLASMA ENHANCED ATOMIC LAYER DEPOSITION PROCESS

(75) Inventors: Thomas Jackson, University Park, PA (US); Devin A. Mourey, University Park, PA (US); Dalong Zhao, San Jose, CA (US)

(73) Assignee: Penn State Research Foundation, University Park, PA (US)

(21) Appl. No.: 12/872,040

(22) Filed: Aug. 31, 2010

Related U.S. Application Data
(60) Provisional application No. 61/238,555, filed on Aug. 31, 2009.

(51) Int. Cl. C08F 2/46

(52) U.S. Cl. 427/488

(57) ABSTRACT

Improved systems, methods and compositions for plasma enhanced atomic layer deposition are herein disclosed. According to one embodiment, a method includes exposing a substrate to a first process material to form a film comprising at least a portion of the first process material at a surface of the substrate. The substrate is exposed to a second process material and the second process material is activated into plasma to initiate a reaction between at least a portion of the first process material and at least a portion of the second process material at the surface of the substrate.

### CROSS REFERENCE TO RELATED APPLICATIONS

This application claims priority from U.S. provisional application No. 61/238,555, entitled “IMPROVED PLASMA ENHANCED ATOMIC LAYER DEPOSITION PROCESS,” filed on Aug. 31, 2009, which is incorporated by reference in its entirety, for all purposes, herein.

### FIELD OF TECHNOLOGY

The present application is directed to the fabrication of semiconductors. More particularly, the present application is directed to improved systems, methods and compositions for plasma enhanced atomic layer deposition (PEALD).

### BACKGROUND

Thin film oxide semiconductors have been fabricated using a variety of techniques including sputtering, plasma enhanced chemical vapor deposition (PECVD), atomic layer deposition (ALD), and plasma enhanced atomic layer deposition (PEALD).

PEALD and ALD are cyclic deposition processes wherein a substrate or sample is exposed to various precursors or materials in succession. The sample is exposed to a first material to form an absorbed layer. The excess of the first material is removed by pumping or purging and a second material is introduced to react with the first material to form a deposited material layer. The two materials are selected specifically to react with one another to form the deposited material layer.

During the ALD process the tendency of the two materials to react, typically at an elevated deposition temperature, is used to drive the material layer deposition. During the PEALD process, plasma energy is used to enhance the reaction between the two materials or to provide other desirable film characteristics. However, the free reaction between process materials before temperature is increased in ALD or before plasma is introduced in PEALD can adversely affect film uniformity and film deposition control of ALD and PEALD processes. Additionally, current ALD and PEALD processes require lengthy processing times and complex deposition systems.

Therefore, there is a need in the field of art for improved systems, methods and compositions for plasma enhanced atomic layer deposition.

### SUMMARY

Improved systems, methods and compositions for plasma enhanced atomic layer deposition are herein disclosed.

According to one embodiment, a method includes exposing a substrate to a first process material to a form film comprising at least a portion of the first process material at a surface of the substrate. The substrate is exposed to a second process material and the second process material is activated into plasma to initiate a reaction between at least a portion of the first process material and at least a portion of the second process material at the surface of the substrate.

The foregoing and other objects, features and advantages of the present disclosure will become more readily apparent from the following detailed description of exemplary embodiments as disclosed herein.

### BRIEF DESCRIPTION OF THE DRAWINGS

Embodiments of the present application are described, by way of example only, with reference to the attached Figures, wherein:

FIG. 1 illustrates a schematic view of an exemplary deposition system for depositing a composite material layer on a substrate according to one embodiment;

FIG. 2 illustrates a flow chart of an exemplary deposition process according to one embodiment;

FIG. 3A illustrates a comparative example of a prior art PEALD process; and

FIG. 3B illustrates an exemplary PEALD process according to one embodiment.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, methods, procedures and components have not been described in detail so as not to obscure the embodiments described herein.

Improved systems, methods and compositions for plasma enhanced atomic layer deposition are herein disclosed. A substrate can be exposed to a first process material to form a film comprising at least a portion of the first process material at a surface of the substrate. The substrate is also exposed to a second process material. The second process material is activated into plasma to initiate a reaction between at least a portion of the first process material and at least a portion of the second process material at the surface of the substrate.

The substrate is a material upon which the plasma enhanced atomic layer deposition can be conducted. The substrate can be a semiconductor substrate comprising at least one compound including, but not limited to silicon, aluminum, oxygen, carbon, polyimides polyesters, polycarbonate and other polymeric substrates.

The first process material can be any organometallic precursor or dopant including, but not limited to Zn(C₂H₅)₂ (DEZ), Zn(CH₃)₂ (DMZ), SiH₄(C₂H₅)₂, Si(OC₂H₅)₄ (TEOS), Ti(OC₃H₇)₄ (TTIP), Zr(OC₄H₉)₄ (ZTB), Hf(OC₄H₉)₄ (HfTB), [Al(CH₃)₃]₂ (TMAl), [Al(C₂H₅)₃]₂ (TEAl), Ga(CH₃)₂ (TMG), Ga(C₂H₅)₃ (TEG), (C₁₁H₁₉O₂)₃Y (Y(dpm)₃), Tris(2,2,6,6-tetramethylheptane-3,5-dionate)yittrium (Y(THD)₃), Tris(2,2,6,6-tetramethylheptane-3,5-dionate)lanthanum (La(THD)₃), Ta(OC₂H₅)₅, dimethyl compounds of cadmium, dimethyl compounds of tellurium, trimethyl compounds of indium, other silicon-based precursors, other zirconium-based precursors, other hafnium-based precursors, tin-based precursors, copper-based precursors, metal halides such as aluminum trichloride and any other organometallic precursors capable of forming oxide semiconductors.

The second process material is a low reactive oxygen precursor that does not freely react with the first process material and can include, but is not limited to CO₂ (carbon dioxide), N₂O (nitrous oxide), (C₂H₅)₂Zn (diethyl zinc), NO (nitric oxide), CO (carbon monoxide), Crown ethers such as Benzo-15-crown-5,15-crown-5,19-crown-6, dibenzo-18-crown-6, and dibenzo-24-crown-8, carbonyls including ketones, diketones, aldehydes, esters, and amides, enones such as acetone, 2-hexanone, 3-hexanone, cyclohexanediones, hexafluoroacetylacetone, 2-thenoyltrifluoroacetone, oxaloacetate, cyclohexanone, 2,3-butanedione, 2-isobutyrylcyclohexanone, 6,6,7,7,8,8,8-heptafluoro-2,2-dimethyl-3,5-octanedione, 2,2,6,6-tetramethylheptane-3,5-dione, 2,2,6,6-tetramethyl-3,5-octanedione, formaldehyde, acetaldehyde, benzaldehyde, ethyl methyl ketone, iso-propyl methyl ketone, iso-butyl methyl ketone, ethyl formate, propyl formate, isobutyl formate, methyl acetate, ethyl acetate, propyl acetate, butyl acetate, isobutyl acetate, methyl propionate, propyl propionate, methyl butyrate, ethyl butyrate, other low reactive organic materials containing oxygen, other low reactive materials containing OH, alcohols and any other low reactive oxygen containing precursors that do not freely react with the first process material.

The first and the second process materials can be reacted in the exemplary deposition processes herein disclosed to create oxide semiconductors including at least one compound selected from the group consisting of ZnO, GaInZnO, InZnO, GaZnO, zinc-tin oxide, tin oxide, indium-tin-oxide, Al₂O₃ and Cu₂O.

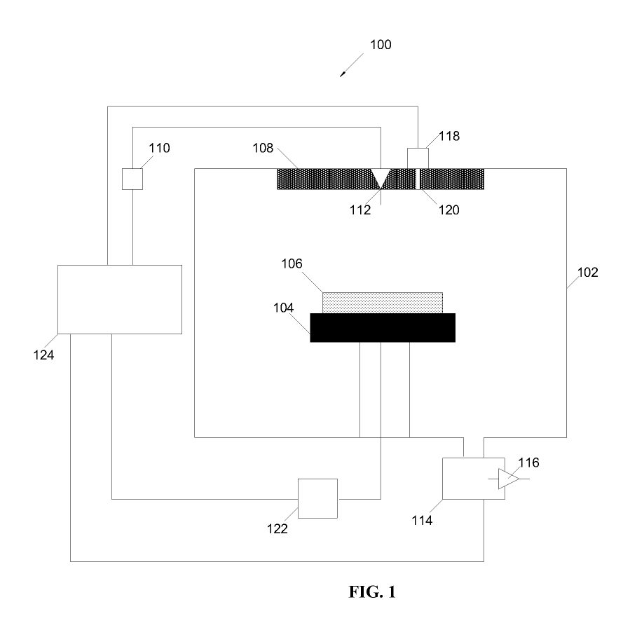

FIG. 1 illustrates a schematic view of an exemplary deposition system 100 for depositing a composite material layer on a substrate according to one embodiment. The deposition system 100 includes a process chamber 102 wherein a substrate carrier 104 is configured to support a substrate 106 upon which material is deposited. The process chamber 102 may further include a material injection assembly 108 for injecting material into the process chamber 102. A material delivery system 110 supplies material to the process chamber 102 through a material injection valve 112 within the material injection assembly 108. A first material and a second material are supplied in a gaseous phase to the process chamber 102 from the material delivery system 110.

The first process material may include an organometallic precursor herein disclosed comprising a primary atomic or molecular species that is deposited as a film on the substrate 106 when the substrate 106 is exposed to the first process material. The second process material is a low reactive oxygen precursor herein disclosed that does not freely react with the first process material.

In an exemplary embodiment, the first process material and the second process material can be introduced into the process chamber 102 in alternating cycles. The second process material can be continuously supplied to the process chamber 102 during deposition. The first process material and the second process material can also be simultaneously introduced into the process chamber 102.

In another exemplary embodiment, the second process material can be used as a carrier gas to deliver the first process material to the process chamber 102. A separate material delivery system is not required to separately deliver the first and second process materials because the second process material is substantially inert and does not freely react with the first process material.

After the first process material and/or the second process material are introduced into the process chamber 102, excess material can be removed by purging with an inert purging gas. The inert purging gas can be delivered to the process chamber 102 from the material delivery system 110 and through the material injection valve 112.

A separate gas purging system is not required and the second process material can be used as the inert purging gas because the second process material is substantially inert and does not freely react with the first process material. In an exemplary embodiment, the second process material can be combined with hydrogen (H₂) to form a purge gas used to purge the first process material from the process chamber.

The pressure control system 114 evacuates excess material from the process chamber 102 through a control valve 116 or an outlet. The pressure control system 114 can be any system, such as a vacuum pump for controllably evacuating the process chamber 102 to a pressure suitable for forming a film and depositing material on the substrate 106. The introduction of the first process material into the process chamber 102 results in the formation of a film comprising at least a portion of the first process material on the substrate 106. The introduction of the second process material into the process chamber 102 does not result in deposition of material on the substrate 106 because it is substantially inert. The addition of plasma is required to initiate and drive the deposition of a composite material layer on the substrate 106.

A plasma generation system generates plasma within the process chamber 102 to increase the reactivity of the second process material within the process chamber 102 by cracking the second process material and generating oxygen radicals that react with the first process material. The plasma generation system can include a primary power source 118 comprising a radio frequency power generator configured to supply radio frequency power to at least one electrode 120 which generates plasma within the process chamber 102. Oxygen radicals react with the first process material. A composite material layer comprising at least a portion of the first process material and oxygen is deposited on the substrate 106. The process can be repeated any number of times to deposit a plurality of composite material layers on the substrate 106. If a purge gas including the second process material and hydrogen (H₂) is used prior to plasma generation, the plasma will react with the purge gas to form water as a byproduct.

The deposition system 100 can also include a substrate temperature control system 122 for controlling the temperature of the substrate 106 during deposition. The substrate temperature control system 122 can include cooling elements, such as a re-circulating coolant flow system that receives heat from the substrate through the substrate carrier 104 and transfers the heat to a cooling heat exchanger (not shown). The substrate temperature control system 122 can also include heating elements, such as resistive heating elements or thermoelectric heating elements that heat the substrate 106 to an optimum deposition temperature before and during deposition.

A controller 124 can be used to configure and control the function of the deposition system 100 and components thereof including the material delivery system 110, the material injection valve 112, the pressure control system 114, the control valve 116, the plasma generation system and the temperature control system 122. The controller 124 can include a microprocessor and software to process, store and output data generated by components of the deposition system 100.

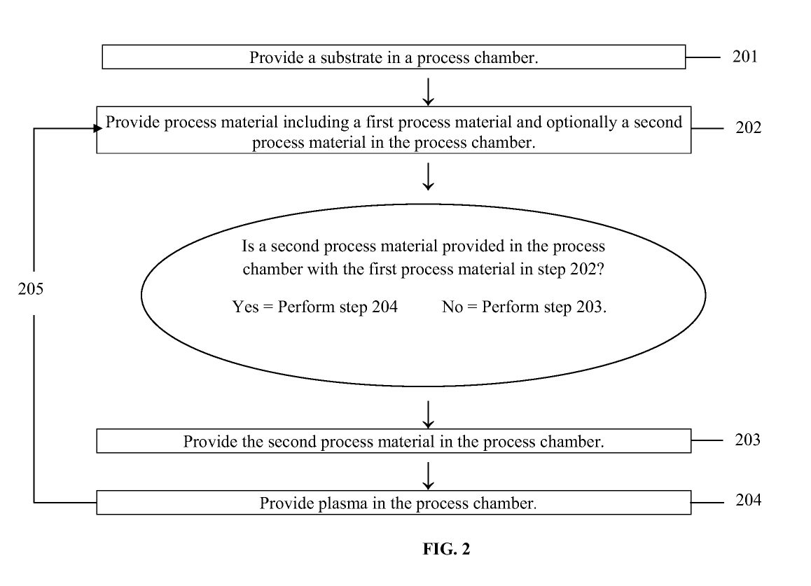

FIG. 2 illustrates a flow chart of an exemplary deposition process according to one embodiment. The deposition system illustrated in FIG. 1 can be used to perform the process described in FIG. 2.

In step 201, a substrate, such as a semiconductor substrate is provided in a process chamber. The process chamber can be any sterile chamber wherein the temperature and pressure can be controlled and the substrate and process materials can be isolated. In step 202, process material is provided in the process chamber. Process material can include a first process material, a second process material or a combination of the first and second process materials.

The first process material can be any organometallic precursor or dopant including, but not limited to Zn(C₂H₅)₂ (DEZ), Zn(CH₃)₂ (DMZ), SiH₄(C₂H₅)₂, Si(OC₂H₅)₄ (TEOS), Ti(OC₃H₇)₄ (TTIP), Zr(OC₄H₉)₄ (ZTB), Hf(OC₄H₉)₄ (HfTB), [Al(CH₃)₃]₂ (TMAl), [Al(C₂H₅)₃]₂ (TEAl), Ga(CH₃)₂ (TMG), Ga(C₂H₅)₃ (TEG), (C₁₁H₁₉O₂)₃Y (Y(dpm)₃), Tris(2,2,6,6-tetramethylheptane-3,5-dionate)yittrium (Y(THD)₃), Tris(2,2,6,6-tetramethylheptane-3,5-dionate)lanthanum (La(THD)₃), Ta(OC₂H₅)₅, dimethyl compounds of cadmium, dimethyl compounds of tellurium, trimethyl compounds of indium, other silicon-based precursors, other zirconium-based precursors, other hafnium-based precursors, tin-based precursors, copper-based precursors, metal halides such as aluminum trichloride and any other organometallic precursors capable of forming oxide semiconductors.

The second process material is a low reactive oxygen precursor that does not freely react with the first process material and can include, but is not limited to CO₂ (carbon dioxide), N₂O (nitrous oxide), (C₂H₅)₂Zn (diethyl zinc), NO (nitric oxide), CO (carbon monoxide), Crown ethers such as Benzo-15-crown-5,15-crown-5,19-crown-6, dibenzo-18-crown-6, and dibenzo-24-crown-8, carbonyls including ketones, diketones, aldehydes, esters, and amides, enones such as acetone, 2-hexanone, 3-hexanone, cyclohexanediones, hexatluoroacetylacetone, 2-thenoyltrifluoroacetone, oxaloacetate, cyclohexanone, 2,3-butanedione, 2-isobutyrylcyclohexanone, 6,6,7,7,8,8,8-heptafluoro-2,2-dimethyl-3,5-octanedione, 2,2,6,6-tetramethylheptane-3,5-dione, 2,2,6,6-tetramethyl-3,5-octanedione, formaldehyde, acetaldehyde, benzaldehyde, ethyl methyl ketone, iso-propyl methyl ketone, iso-butyl methyl ketone, ethyl formate, propyl formate, isobutyl formate, methyl acetate, ethyl acetate, propyl acetate, butyl acetate, isobutyl acetate, methyl propionate, propyl propionate, methyl butyrate, ethyl butyrate, other low reactive organic materials containing oxygen, other low reactive materials containing OH, alcohols and any other low reactive oxygen containing precursors that do not freely react with the first process material.

In an exemplary embodiment, the first process material and the second process material can be introduced into the process chamber in alternating cycles. The second process material can be continuously supplied to the process chamber during deposition. The first process material and the second process material can also be simultaneously introduced into the process chamber.

In another exemplary embodiment, the second process material can be used as a carrier gas to deliver the first process material to the process chamber. A separate material delivery system is not required to isolate delivery of the first and second process materials because the second process material is substantially inert and does not freely react with the first process material. When the substrate is exposed to the first process material, a film comprising at least a portion of the first process material is formed on the substrate.

If the second process material is not provided in the process chamber with the first process material in step 202, the second process material is provided in step 203. The introduction of the second process material into the process chamber does not result in deposition of material on the substrate. If the second process material is provided in the process chamber with the first process material in step 202, plasma is provided in the process chamber at step 204. The addition of plasma in step 204 is required to initiate and drive the deposition of a composite material layer on the substrate.

After the first process material and/or the second process material are introduced into the process chamber, excess material can be removed by purging with an inert purging gas. A separate gas purging system is not required and the second process material can be used as the inert purging gas because the second process material is substantially inert and does not freely react with the first process material. In an exemplary embodiment, the second process material can be combined with hydrogen (H₂) to form a purge gas used to purge the first process material from the process chamber.

An optimized environment can be obtained in the process chamber by controlling the temperature and pressure in the process chamber before the deposition is initiated by providing plasma in step 204. Film uniformity is improved when an optimized environment is created before initiating the layer deposition reaction.

In an exemplary embodiment, an optimized deposition environment can be established and deposition can be conducted at a temperature range of about 20-400° C. and a pressure range of about 0.1-10 torr. Other temperature and pressure ranges for conducting deposition will be apparent to those of ordinary skill in the art.

The systems, methods and compositions herein disclosed improve film deposition control because the energy supplied for the reaction is optimized through temperature, pressure and plasma energy control without having to account for competing reactions between the first process material and the second process material.

Plasma is provided in the process chamber in step 204 by introducing electromagnetic power, including but not limited to RF power, microwave frequency power, light wave power or other power capable of generating plasma in the process chamber. Plasma within the process chamber increases the reactivity of the second process material by cracking the second process material and generating oxygen radicals that react with the first process material. Oxygen radicals react with the first process material and a composite material layer comprising at least a portion of the first process material and oxygen is deposited on the substrate.

In step 205, the process can be repeated any number of times from step 202 to deposit a plurality of composite material layers on the substrate. If a purge gas including the second process material and hydrogen (H₂) is used prior to plasma generation, the plasma will react with the purge gas to form water as a byproduct.

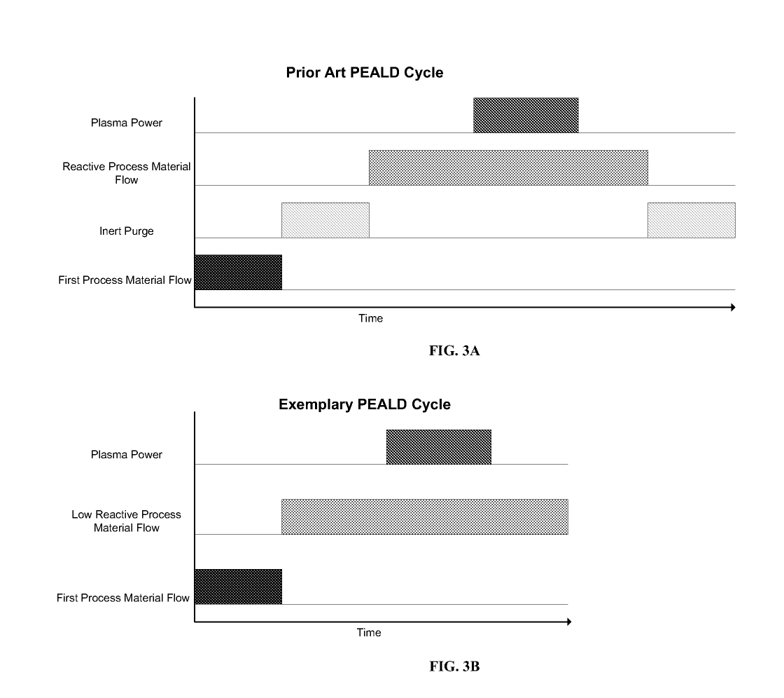

FIG. 3A illustrates a comparative prior art PEALD process. In prior art PEALD processes, a substrate is exposed to a first process material to form an absorbed layer of the first process material. All excess of the first process material must then be purged with an inert gas before exposing the substrate to a reactive process material because the reactive process material will otherwise react with the first process material. The second process material is exposed to plasma to further facilitate the reaction between the first process material and the reactive process material during deposition upon the substrate. The reactive process material must then be purged to avoid further reaction with the composite material layer deposited on the substrate. At least two purging steps per deposition cycle are required in prior art PEALD processes to prevent undesirable reaction between the reactive process material and the first process material. Therefore, prior art PEALD processes require more time per deposition cycle. Prior art PEALD processes also require complex isolation, piping and purging systems to isolate the first process material from the reactive process material during delivery, deposition and purging.

FIG. 3B illustrates an exemplary PEALD process according to one embodiment. A substrate is exposed to a first process material to form a film layer comprising at least a portion of the first process material on the substrate. The substrate is then exposed to a low reactive process material. The low reactive process material must be converted to plasma to initiate and drive the reaction between the first process material and the low reactive process material and to initiate deposition of a composite material layer on the substrate. No purging steps are required to prevent undesirable reaction between the low reactive process material and the first process material. Therefore, the exemplary PEALD processes herein disclosed reduce the time per deposition cycle and eliminate the need for complex isolation, piping and purging systems.

In an exemplary embodiment, the first process material is diethylzinc (DEZ) and the low reactive process material is N₂O (nitrous oxide). A flow of nitrous oxide gas is bubbled through liquid DEZ. The nitrous oxide absorbs the DEZ and acts as a carrier gas. The substrate is exposed to the nitrous oxide containing absorbed DEZ. A film layer comprising at least zinc is formed on the substrate.

The nitrous oxide is then exposed to plasma to crack the nitrous oxide and generate oxygen radicals. Oxygen radicals react with the film layer comprising at least zinc and a composite material layer comprising ZnO (zinc oxide) is deposited on the substrate. The process can be repeated to deposit a plurality of composite material layers of zinc oxide on the substrate.

Example embodiments have been described hereinabove regarding improved systems, methods and compositions for plasma enhanced atomic layer deposition. Various modifications to and departures from the disclosed example embodiments will occur to those having ordinary skill in the art. The subject matter that is intended to be within the spirit of this disclosure is set forth in the following claims.

What is claimed is:

1. A method of depositing material on a substrate comprising:
exposing a substrate to a first process material to form a film comprising at least a portion of the first process material at a surface of the substrate;
exposing the substrate to a second process material; and
activating the second process material into plasma to initiate a reaction between the second process material and the film formed at the surface of the substrate;
permitting an oxide containing layer to form at the surface of the substrate.

2. The method as recited in claim 1, wherein exposing the substrate to a second process material comprises purging at least a portion of the first process material with the second process material.

3. The method as recited in claim 1, wherein the second process material does not react with the first process material prior to activation.

4. The method as recited in claim 1, wherein the second process material is a low reactive process comprising at least one of CO₂, N₂O, (C₂H₅)₂Zn, NO, CO, benzo-15-crown-5,15-crown-5, 19-crown-6, dibenzo-18-crown-6, dibenzo-24-crown-8, acetone, 2-hexanone, 3-hexanone, cyclohexanediones, hexafluoroacetylacetone, 2-thenoyltrifluoroacetone, oxaloacetate, cyclohexanone, 2,3-butanedione, 2-isobutyrylcyclohexanone, 6,6,7,7,8,8,8-heptafluoro-2,2-dimethyl-3,5-octanedione, 2,2,6,6-tetramethylheptane-3,5-dione, 2,2,6,6-tetramethyl-3,5-octanedione, formaldehyde, acetaldehyde, benzaldehyde, ethyl methyl ketone, iso-propyl methyl ketone, iso-butyl methyl ketone, ethyl formate, propyl formate, isobutyl formate, methyl acetate, ethyl acetate, propyl acetate, butyl acetate, isobutyl acetate, methyl propionate, propyl propionate, methyl butyrate, ethyl butyrate, an alcohol, a ketone, a diketone, an aldehyde, an ester, and an amide.

5. The method as recited in claim 1, wherein the first process material comprises at least one compound selected from the group consisting of: Zn(C₂H₅)₂ (DEZ), Zn(CH₃)₂ (DMZ), SiH₄(C₂H₅)₂, Si(OC₂Hs)₄ (TEOS), Ti(OC₃H₇)₄ (TTIP), Zr(OC₄H₉)₄ (ZTB), Hf(OC₄H₉)₄ (HfTB), [Al(CH₃)₃]₂ (TMAl), [Al(C₂H₅)₃]₂ (TEAl), Ga(CH₃)₂ (TMG), Ga(C₂H₅)₃ (TEG), (C₁₁H₉O₂)₃Y (Y(dpm)₃), Tris(2,2,6,6-tetramethylheptane-3,5-dionate)yittrium (Y(THD)₃), Tris(2,2,6,6-tetramethylheptane-3,5-dionate)lanthanum (La(THD)₃), Ta(OC₂H₅)₅, dimethyl compounds of cadmium, dimethyl compounds of tellurium, trimethyl compounds of indium, silicon-based precursors, zirconium-based precursors, hafnium-based precursors, tin-based precursors, copper-based precursors and metal halides.

6. The method as recited in claim 1, wherein the substrate is exposed to the first process material and the second process material substantially simultaneously.

7. The method as recited in claim 1, wherein the substrate is exposed to the first process material before the substrate is exposed to the second process material.

8. The method as recited in claim 1, wherein the oxide containing layer comprises at least one compound selected from the group consisting of: ZnO, GalnZnO, InZnO, GaZnO, zinc-tin oxide, tin oxide, indium-tin-oxide, Al₂O₃ and Cu₂O.
